(19) United States
(12) Patent Application Publication
(10) Pub. No.: US 2014/0295029 A1
(43) Pub. Date: Oct. 2, 2014

(54) Method for cup packaging coffee or tea beverages

(71) Applicants: Ted Chao, Claremont, CA (US); Jane Zheng, Claremont, CA (US); Diana Chao, Claremont, CA (US); Roark Chao, Claremont, CA (US)

(72) Inventors: Ted Chao, Claremont, CA (US); Jane Zheng, Claremont, CA (US); Diana Chao, Claremont, CA (US); Roark Chao, Claremont, CA (US)

(21) Appl. No.: 13/773,732

(22) Filed: Mar. 28, 2013

(51) Int. Cl. B65D 85/816; A23F 5/40; B65D 81/32; A23F 3/30

(52) U.S. Cl. CPC B65D 85/816; A23F 3/30; A23F 5/40; B65D 81/3238; B65D 2081/008
USPC 426/86; 426/115

(57) ABSTRACT

The cup packaging coffee or tea beverage includes an instant components-mix, sugar, and a stir stick; it is convenient to make a gourmet drink quickly for just adding hot or cold water.

### RELATED APPLICATIONS

This application claims the benefit under 35 U.S.C. .sctn. 119(e) of U.S. Provisional Application No. 61/763,649, filed Feb. 12, 2013, titled “System and method for convenience packaging coffee or tea,” the entirety of which is incorporated herein by reference.

### BACKGROUND OF THE INVENTION

Most people enjoy having a cup of coffee or tea in the morning, at work, during School, or simply throughout the day. These beverages are typically needed by most people every day. In the morning, it is a hassle to wait a long line in cafe ship; if at home, individuals have to purchase, store, locate, and use many separate containers and equipment, which can be time consuming and inconvenient as well. An effective solution is necessary. It can save a lot of time, increase efficiency, so this invention is very meaningful.

### BRIEF SUMMARY OF THE INVENTION

The cup packaging coffee or tea beverage for use with adding water and adjustable sugar by the user self in a convenient way, it comprising: a coffee cup, a lid, an instant components-mix packet (instant coffee, instant tea, instant juice, instant coconut, instant almond, instant bean, instant milk or other instant powder), one or several sugar packets, and a stir stick. Anyone who likes to have a quick-to-go gourmet coffee or tea will appreciate the convenience and practicality that this packaging affords.

### DETAILED DESCRIPTION OF INVENTION

The cup packaging coffee or tea beverage for use with adding water and adjustable sugar by the user self in a convenient way, it comprising: a coffee cup, a lid, an instant components-mix packet (instant coffee, instant tea, instant juice, instant coconut, instant almond, instant bean, instant milk or other instant powder), one or several sugar packets, and a stir stick. The packaging size can vary; it can be 8 oz, 12 oz, 16 oz, 20 oz or more. In addition to the packaging of the product can vary, depending on its use.

### BRIEF DESCRIPTION OF DRAWINGS ATTACHED

FIG. 1 shows the inside of the cup packaging coffee or tea beverages: an instant components-mix packet (instant coffee, instant tea, instant juice, instant coconut, instant almond, instant bean, instant milk or other instant powder), one or several sugar packets, and a stir stick.

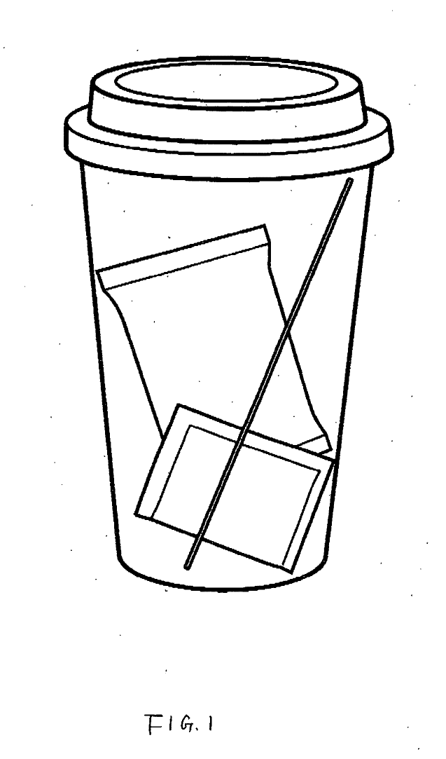

FIG. 2 shows the outside of the cup packaging coffee or tea beverages.

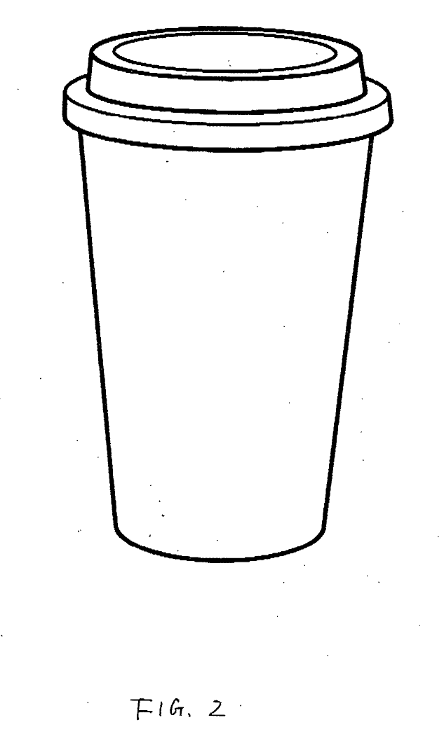

FIG. 3 shows the method to make a cup of beverage instantly by using the cup packaging coffee or tea beverages.

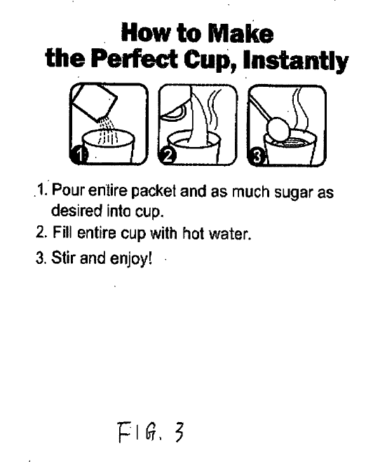

the foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

1. the cup packaging coffee or tea includes an instant components-mix packet or instant components powder mix without packet, sugar packet or without packet, and a stir stick; it is convenient to make a gourmet drink quickly for just adding hot or cold water.

2. the cup of claim 1, the cup is coffee cup, which is made with paper or other materials.

3. the instant beverage components-mix packet and powder-mix without packet of claim 1, includes instant coffee, instant tea, instant juice, instant coconut, instant almond, instant soy milk, instant milk or other instant powder.

4. the instant beverage components-mix packet and powder-mix without packet of claim 3, comprises dry extract and micro-ground of coffee, tea, fruits, nuts, milk or others.

5. the instant beverage components-mix packet of claim 1 is packed with aluminum foil paper or other material.

6. the stir stick of claim 1 is made with wood, plastic or other material.
